(19) United States
(12) Patent Application Publication
(10) Pub. No.: US 2005/0280612 A1
(43) Pub. Date: Dec. 22, 2005

(54) Matrix type display unit and method of driving the same

(76) Inventors: Yosuke Yamamoto, Tokyo (JP); Hisafumi Motoe, Saitama (JP); Satoshi Miura, Kanagawa (JP); Takeya Meguro, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/156,663

(22) Filed: Jun. 21, 2005

(30) Foreign Application Priority Data
Jun. 22, 2004 (JP) 2004-183507

(51) Int. Cl. G09G 3/22

(52) U.S. Cl. 345/75.2

(57) ABSTRACT

A matrix type display unit includes a plurality of row wires, and a plurality of column wires, and the matrix type display unit includes a scanning signal applying section performing scanning on each frame of image display through sequentially and alternatively applying a scanning signal to each of the plurality of row wires on a line-by-line basis with normal scan timing, and sequentially and alternatively applying the scanning signal again with scan timing delayed for a predetermined period from the normal scan timing after applying the scanning signal, and a modulation signal applying section applying a modulation signal corresponding to each pixel to a pixel on a line to which the scanning signal is applied with the normal scan timing and a pixel on a line to which the scanning signal is applied with the delay scan timing.

### BACKGROUND OF THE INVENTION

1. Field of the Invention

The present invention relates to a display unit in which a display pixel is formed at an intersection of electrode wiring arranged in a matrix form, and light emission is controlled by line sequential scanning, for example, a matrix type display unit suitable for a FED (Field Emission Display) or an EL (Electroluminescence) display, and a method of driving the display unit.

2. Description of the Related Art

In recent years, displays have become thinner and flatter. As one of flat panel display sections (flat panel displays, hereinafter simply referred to as displays) used for display units, for example, a display using a field emission cathode has been developed. As the display using the field emission cathode, a FED is known. The FED can increase gray level while securing a viewing angle, and the FED has a large number of advantages such as superior image quality, high production efficiency, high response speed, the capability to operate under an extremely low temperature environment, high brightness and high power efficiency. Moreover, the manufacturing process of the FED is simpler than the manufacturing process of a so-called active matrix liquid crystal display, and it is expected that the manufacturing cost of the FED is at least 40% to 60% lower than that of the active matrix liquid crystal display.

Here, the basic structure and the operation of the FED will be described below. The FED is a display device in which electrons are emitted from a field emission cathode through the use of field electron emission characteristics, and an acceleration electric field is applied to the electrons to accelerate the electrons, and then the electrons hit an anode electrode coated with phosphor to obtain light emission.

The field emission cathode includes, for example, a conical cathode device (cold cathode device) and a cathode electrode which is electrically connected to the base of the cathode device. Moreover, on a side facing the cathode electrode, a gate electrode is disposed with the cathode device in between. When a voltage Vgc is applied between the cathode electrode and the gate electrode facing each other, electrons are emitted from the cathode device. An anode electrode as an acceleration electrode is disposed on a side facing the field emission cathode and the gate electrode. When a high voltage HV is applied to the anode electrode, the electrons emitted from the cathode device are accelerated to hit a phosphor which is applied to the anode electrode, thereby light is emitted.

In general, in the FED, the gate electrode is connected to row direction (Row) wires and column direction (Column) wires to carry out matrix wiring, and the cathode device is disposed at each intersection of the wires so as to form pixels in a matrix form. A modulation signal is inputted from the column direction wire side, and a scanning signal is sequentially applied from the row direction wire side to perform scanning. When a row wire selection voltage Vrow as a scanning signal is applied to the gate electrode from a row direction, and a column wire drive voltage Vcol as a modulation signal is applied to the cathode electrode from a column direction, a voltage difference between the gate electrode and the cathode electrode which is expressed in voltage Vgc occurs, and by an electric field generated by the voltage Vgc, electrons are emitted from the cathode device. At this time, when a high voltage HV is applied to the anode electrode, electrons are attracted to the anode electrode under the following condition, thereby an anode current Ia flows from the anode electrode in a direction toward the cathode electrode.
HV>Vrow (1)

At this time, when a phosphor is applied to the anode electrode, the phosphor emits light by the energy of the electrons.

Depending upon the magnitude of the voltage Vgc, the amount of emitted electrons changes, thereby the anode current Ia changes. In this case, the light emission amount of the phosphor, that is, light emission brightness L has the following relationship.
L∝Ia (2)

Therefore, when the voltage Vgc is changed, the light emission brightness L can be changed. In other words, when the amount of electron emission is controlled by the magnitude of the voltage Vgc, desired light emission can be obtained. Therefore, when the voltage Vgc is modulated according to a signal to be displayed, brightness modulation can be achieved.

FIG. 1 shows an example of an electron emission characteristic (a current-voltage characteristic (IV characteristic)) in the cathode device. The horizontal axis indicates the voltage Vgc, and the vertical axis indicates the current Ic. As shown in FIG. 1, in the cathode device, although a small current start flowing from a threshold Vo, electrons contributing to light emission are not emitted at a cutoff voltage Von (for example, 20 V) or less, and when a voltage exceeding the cutoff voltage Von is applied as the voltage Vgc, electrons are emitted to generate a current contributing to light emission.

A specific method of driving a FED having such an emission characteristic will be described below. As the row wire selection voltage Vrow, for example, a voltage of 35 V at the time of selection or a voltage of 0 V at the time of non-selection is applied. On the other hand, as the column wire drive voltage Vcol, for example, a modulation signal of 0 to 15 V is applied according to an input image signal level.

For example, when the row wire selection voltage Vrow is in a selection state, that is, a voltage of 35 V is applied, in the case where the column wire drive voltage Vcol is 0 V, a difference voltage Vgc between a gate and a cathode is 35 V, so the amount of electrons emitted from the cathode device increases, and emitted light in the phosphor has high brightness.

Likewise, when the row wire selection voltage Vrow is in a selection state, that is, 35 V is applied, in the case where the column wire drive voltage Vcol is 15 V, the difference voltage Vgc between the gate and the cathode is 20 V; however, emitted electrons have the emission characteristic shown in FIG. 1, so when the difference voltage Vgc is 20 V, enough electrons to contribute to light emission are not emitted. Therefore, light emission does not occur. As described above, when the row wire selection voltage Vrow is brought into a selection state, and the column wire drive voltage Vcol is controlled within a range from 0 V to 15 V according to an input image signal level, desired brightness can be displayed.

In the case where a panel is successively displayed, while cathode device arrays are sequentially driven (scanned) on a row-by-row basis through applying the row wire selection voltage Vrow to the gate electrode, a modulation signal (column wire drive voltage Vcol) for one line of an image is applied at the same time, thereby an amount of electron beam irradiation to the phosphor is controlled to display an image on a line-by-line basis.

Here, the structure of a circuit in a related art for generating the row wire selection voltage Vrow and the column wire drive voltage Vcol will be briefly described below. The row wire selection voltage Vrow and the column wire drive voltage Vcol are generated on the basis of an image signal outputted from an image signal processing portion (not shown). The image signal includes, for example, 8-bit digital image signals for R (red), G (green) and B (blue), a horizontal synchronous signal and a vertical synchronous signal.

Among them, the digital image signals for R, G and B are inputted into a column direction drive voltage generating portion 130 as shown in FIG. 2A. The column direction drive voltage generating portion 130 (not shown) mainly includes a shift register for inputting a digital image signal for one line (=a 1H period (1 horizontal scanning period)), a line memory for holding the image signal for a 1H period, a D/A (digital/analog) converter for converting the digital image signal for a 1H period into an analog voltage to apply the voltage for a 1H period, and the like. A plurality of column direction wires R1, G1 and B1 through RN, GN and BN (hereinafter each column direction wire is generically called a column direction wire 150) for R, G and B are connected to the column direction drive voltage generating portion 130, and the column wire drive voltage Vcol is applied to each column direction wire for a 1H period at the same time. In the related art, as shown in FIG. 2B, generally all cathode electrodes 310 in one array are connected to one column direction wire 150.

On the other hand, the horizontal synchronous signal and the vertical synchronous signal are inputted into a control signal generating portion (not shown), and in the control signal generation portion, an image capture start pulse for column wire drive which indicates timing for starting to capture an image in the column direction voltage generating portion 130 and a column wire drive start pulse which indicates timing for generating an analog image voltage which is D/A converted in the column direction drive voltage generating portion 130 are produced.

Moreover, the control signal generating portion produces a row wire drive start pulse indicating timing for starting to drive the row wire selection voltage Vrow in the row direction selection voltage generation portion (not shown) and a shift clock for row wire selection as a reference shift clock for sequentially selecting and driving the row wire selection voltage Vrow on a line-by-line basis from above.

FIGS. 3A through 3J show drive timing in the FED in the related art. The image input for column wire drive in FIG. 3B is total 24 bits of digital image signals including 8-bit signals for R, G and B inputted into the column direction drive voltage generating portion 130 in FIG. 2A in parallel, and one pixel is sampled by a reference dot clock for digital image signal reproduction (not shown).

In the column direction drive voltage generating portion 130, just before the image input for column wire drive (for example, 1 clock in dot clock before), the above-described image capture start pulse for column wire drive (refer to FIG. 3A) is detected, and after that, the image input for column wire drive is maintained through capturing the image input for column wire drive in the shift register for one horizontal line of pixels which sequentially stores the image input for column wire drive in synchronization with the dot clock.

Next, in the column direction drive voltage generating portion 130, in synchronization with the above-described column wire drive start pulse (refer to FIG. 3C) detected after one line of image input data for column wire drive is captured, one line of image data is transferred to, for example, the line memory, and the one line of image data held in the line memory is D/A converted on a pixel-by-pixel basis at the same time, and the one line of image data is outputted as the column wire drive voltage Vcol (refer to FIG. 3D) which is an analog voltage. In FIG. 3D, as an example, the column wire drive voltage Vcol for driving the Ath pixel in a horizontal direction (a pixel in the Ath column) is shown as the Ath column wire drive voltage is shown.

On the other hand, in the row direction selection voltage generating portion, the on state of the above-described row wire drive start pulse (refer to FIG. 3F) is detected, for example, on the rising edge of the column wire drive start pulse (refer to FIG. 3C). Then, the row wire selection voltage Vrow is applied to the first row through the last row (refer to FIGS. 3G through 11J) sequentially and alternatively on a line-by-line basis in synchronization with the shift clock for row wire selection (refer to FIG. 3E) on the rising edge of the column wire drive start pulse as a starting point. In the drawings, selection voltages for the first row to the fourth row are shown.

When the difference voltage Vgc between the row wire selection voltage Vrow and the column wire drive voltage Vcol is applied to the cathode device with such timing, the amount of electron beam irradiation to the phosphor can be controlled, and an image is displayed on a line-by-line basis by a line sequential drive. The maximum light emission time per line at this time is determined by a horizontal period of the image signal.

However, in such a line sequential drive, in the case where higher resolution by an increase in the number of pixels in a display and upsizing of the display for image magnification are attempted in future, a problem, that is, a decline in brightness according to a decrease in the light emission period per line by a decline in the horizontal period occurs. For example, in the case of an image signal of 800×600 pixels (generally called SVGA resolution), one horizontal period is approximately 26.4μ sec; however, in an image signal of 1920×1080 pixels (generally called HD resolution), one horizontal period is approximately 14.4μ sec, so a light emission time per line is as follow.
14.4/26.4≈0.54 times

As described above, the light emission time declines almost inversely proportional to an increase in the number of vertical lines, and the brightness declines at the same ratio. Therefore, in the case of the line sequential drive, it is necessary to compensate for a decline in light emission brightness according to such an increase in display resolution in some way.

Therefore, methods of compensating for a decline in light emission brightness in related arts are broadly divided into the following methods.
a) To improve the light emission brightness through increasing light emission brightness per horizontal period.
b) To improve light emission brightness through extending the light emission time to longer than one horizontal period.
   Between them, as is evident from the above-described formula (2), the method a) can be implemented through increasing the emission current density per horizontal period to the phosphor of the light emitting device (cathode device).

Moreover, in addition to the method a), the method b) has been implemented in the past, and the method b) is divided into the following two methods by the structure of column direction wiring.
c) Method of carrying out wiring on the cathode electrode through vertically splitting column direction wires (method by a vertically split wiring structure).
d) Method of doubling the number of column direction wires in a horizontal direction to alternately connect the column direction wires to the cathode electrodes in each row (method by an alternate wiring structure).

FIGS. 5A and 5B show conceptual diagrams of the wiring structure by the method c). As shown in FIG. 5B, in the method c), the column direction wire is vertically split into two, that is, column direction wires 150-1 and 150-2, and the column direction wires 150-1 and 150-2 are controlled by different column direction drive sections (column direction drive voltage generating portions 130-1 and 130-2) above and below the column direction wires 150-1 and 150-2. In other words, the drives of display regions of the display which are vertically split in the middle are controlled separately. A method of extending the light emission time which is implemented in the method c) in the related art will be described below.

At first, for comparison, an example of typical scan timing in typical wiring (refer to FIG. 2B) is shown in FIGS. 4A and 4B. FIG. 4A macroscopically shows scan timing in each scan line in a horizontal direction, and in FIG. 4A, the horizontal direction indicates time, and the vertical direction indicates scan line number. FIG. 4B shows a partially enlarged view of FIG. 4A. For the purpose of describing a difference between the scanning method and other scanning methods, for the sake of convenience, frames are divided into even frames and odd frames. As shown in FIGS. 4A and 4B, in the typical display, the light emission time per line is one horizontal period (=1H), and scanning is performed by 1 line (=1H) from the top line.

Next, FIGS. 6A and 6B show an example of scan timing in the case where the light emission period is improved by the method c) by the vertically split wiring structure. In this case, the light emission time per line extends to 2 horizontal periods (=2H), and the top and bottom row wires and top and bottom column wires of a corresponding pixel are scanned at the same time, so one screen is displayed in a doubled light emission time in one vertical period. However, in this case, there is a problem that when moving images are followed in a central portion of the screen vertically split (a boundary between a top screen and a bottom screen), discontinuity occurs. The problem is caused by a mismatch of scanning order in one vertical period of the image signal.

Therefore, in order to overcome the problem, a driving method of FIGS. 7A and 7B in which the mismatch of scanning order at a boundary between the top screen and the bottom screen has been proposed. In the driving method, the conditions that the light emission time per line extends to 2H and the top screen and the bottom screen are scanned at the same time are the same as in the method of FIGS. 6A and 6B. However, in this scanning method, in order to overcome the discontinuity of scanning order which occurs at a boundary between the top screen and the bottom screen, the scanning order of the bottom screen is delayed by one frame. Thereby, temporal continuity of screen scanning at the boundary between the top screen and the bottom screen is provided. When such a drive is performed, discontinuity of moving images in the central portion of the screen is surely removed.

However, in this driving method, as is evident from FIGS. 7A and 7B, the image vertical period for scanning one screen is half of a typical input image ( 1/60 sec per period), that is, 1/30 sec. When scanning is performed with this control timing on the basis of the typical input image, there is a problem that screen distortion in moving images occurs more often than in the typical scanning, thereby images are unnaturally displayed. For example, when an object as shown in FIG. 8A in a stationary state is converted into a moving state in which the object horizontally moves from the left of the screen to the right, the object is distorted as shown in FIG. 8B.

Next, a method of improving the brightness by the wiring structure of the above-described method d) will be described below. FIGS. 9A and 9B show conceptual diagrams of the wiring structure by the method d). In the wiring structure, compared to the structure in the related art (refer to FIG. 2B) in which all cathode electrodes 310 in one column are connected to one column direction wire 150, the column direction wires 150 includes two column wires 150-A1 and 150-A2, and the column wired 150-A1 and 150-A2 are alternately connected to cathode electrodes 310-1, 310-2, 310-3, . . . in one column. In other words, compared to the structure of FIG. 2B, column direction wires R1, G1 and B1 through RN, GN and BN for R, G and B include combinations of two wires (R11, R12), (G11, G12), (B11, B12), through (RN1, RN2), (GN1, GN2) and (BN1, BN2), respectively.

In such an alternate wiring structure, the lines in an even row and an odd row can be independently scanned. FIGS. 10A and 10B show an example of scan timing in the case where the light emission time is improved by the driving method using the wiring structure. Moreover, FIGS. 11A and 11B schematically show the concept of scanning by the driving method. In the driving method, the light emission brightness can be improved through scanning two adjacent lines at the same time to emit light from pixels in the two lines at the same time. In this case, light is continuously emitted for a 2H period in each row. In the case of the driving method, problems with image quality are fewer, so the brightness can be improved. In FIG. 11A, a line highlighted with a heavy dotted line indicates a line being scanned, and corresponds to scanning in a portion enclosed with a dotted line in FIG. 11B. In other words, in the driving method, two adjacent lines are continuously scanned, and, for example, as shown in FIG. 11A, after the first row and the second row are scanned at the same time, the second row and the third row are scanned at the same time. The driving method is disclosed in Japanese Unexamined Patent Application Publication No. 2002-123210.

### SUMMARY OF THE INVENTION

However, in any of the above-described methods, in a flat panel display system such as the FED, compared to a CRT (cathode ray tube), the time that an electron beam is applied to 1 pixel is longer, and the current density becomes higher, so the light emission state of the phosphor is easily saturated. When the light emission state of the phosphor is saturated, a decline in peak brightness as well as a decline in gray scale representation specifically on a high brightness side occur, and they become problems.

In view of the foregoing, it is desirable to provide a matrix type display unit capable of overcoming the brightness saturation of a phosphor which may occur when the resolution becomes higher and the screen becomes larger, and improving light emission brightness, and a method of driving the matrix type display unit.

According to an embodiment of the present invention, there is provided a matrix type display unit including a plurality of row wires, and a plurality of column wires which are disposed so as to cross over the plurality of row wires wherein a plurality of display pixels are formed in a matrix form corresponding to intersections of the plurality of row wires and the plurality of column wires, and the matrix type display unit including: a means for applying a scanning signal which performs scanning on each frame of image display through sequentially and alternatively applying a scanning signal to each of the plurality of row wires on a line-by-line basis with normal scan timing, and sequentially and alternatively applying the scanning signal again with scan timing delayed for a predetermined period from the normal scan timing after applying the scanning signal; and a means for applying a modulation signal corresponding to each pixel to a pixel on a line to which the scanning signal is applied with the normal scan timing and a pixel on a line to which the scanning signal is applied with the delay scan timing.

According to an embodiment of the present invention, there is provided a method of driving a matrix type display unit, the matrix type display including a plurality of row wires, and a plurality of column wires disposed so as to cross over the plurality of row wires wherein a plurality of display pixels are formed in a matrix form corresponding to intersections of the plurality of row wires and the plurality of column wires, and the method including: a scanning signal applying step of performing scanning on each frame of image display through sequentially and alternatively applying a scanning signal to each of the plurality of row wires on a line-by-line basis with normal scan timing, and sequentially and alternatively applying the scanning signal again with scan timing delayed for a predetermined period from the normal scan timing after applying the scanning signal; and a modulation signal applying step of applying a modulation signal corresponding to each pixel to a pixel on a line to which the scanning signal is applied with the normal scan timing and a pixel on a line to which the scanning signal is applied with the delay scan timing.

In the matrix type display unit and the method of driving a matrix type display unit according to the embodiment of the invention, each of the plurality of column wires includes a first column wire and a second column wire in each display pixel array, and the first column wire is disposed so as to correspond to a display pixel in an odd row, and the second column wire is disposed so as to correspond to a display pixel in an even row. In this case, for example, when the scanning signal is applied to a row wire in an odd row with normal scan timing, the scanning signal may be applied to a row wire in an even row with delay scan timing, and when the scanning signal is applied to a row wire in an even row with the normal timing, the scanning signal may be applied to a row wire in an odd row with the delay scan timing. Moreover, for example, the control of independently and concurrently applying a modulation signal for each line to a display pixel in an odd row and a display pixel in an even row through independently applying a modulation signal to the first column wire and the second column wire may be performed.

In the matrix type display unit and the method of driving a matrix type display unit according to the embodiment of the invention, each display pixel is controlled by a scanning signal with normal scan timing and a modulation signal corresponding to a pixel on a line to which the scanning signal is applied so as to emit light with normal timing. Moreover, each display pixel is controlled by a scanning signal with delay scan timing and a modulation signal corresponding to a pixel on a line to which the scanning signal is applied so as to emit light with delay scan timing. The light emission from the pixel with such normal scan timing and the light emission from the pixel with such delay scan timing are performed on each frame of image display.

In other words, in the driving method according to the embodiment of the invention, typical line sequential scanning in a related art is performed a plurality of times at an interval of a delay time of a predetermined time (for example, a few H period). Thereby, compared to the typical line sequential scanning in the related art, the brightness can be improved. For example, when delay scanning is performed once, the light emission time is doubled, so compared to the typical line sequential scanning in the related art, the brightness is doubled. Moreover, in the same line, there is a time interval between the light emission by the first scanning (normal scanning) and the light emission by the second scanning (delay scanning), so compared to the case where continuous light emission for, for example, a 2H period is performed to improve the brightness, the brightness saturation of a phosphor can be overcome. Thereby, the gray scale representation on a high brightness side can be improved.

In the matrix type display unit or the method of driving a matrix type display unit according to the embodiment of the invention, a pixel is displayed with normal scan timing on each frame of image display, and the same pixel is displayed again with scan timing delayed for a predetermined period from the normal scan timing after applying the scanning signal with the normal scan timing, so the typical line sequential scanning in the related art can be performed a plurality of times at an interval of a delay time of a predetermined period (for example, a few H periods), thereby compared to the typical line sequential scanning in the related art, the brightness can be improved. Moreover, on the same pixel, there is a time interval between a display period by normal scanning and a display period by delay scanning, so compared to the case where continuous light emission for, for example, a 2H period is performed to improve the brightness, the brightness saturation of the phosphor can be overcome. Thus, the brightness saturation of the phosphor can be overcome specifically in the case where the resolution becomes higher and the screen becomes larger, and the light emission brightness can be improved.

Other and further objects, features and advantages of the invention will appear more fully from the following description.

### BRIEF DESCRIPTION OF THE DRAWINGS

FIG. 1 is a plot showing an electron emission characteristic (a current-voltage characteristic (IV characteristic)) in a cathode device of a FED;

FIGS. 2A and 2B are illustrations showing an example of the structure of column direction wiring in a matrix type display unit in a related art;

FIGS. 3A through 3J are timing charts showing waveforms of various driving signals in the matrix type display unit in the related art;

FIGS. 4A and 4B are illustrations showing an example of scan timing in the matrix type display unit with a wiring structure shown in FIGS. 2A and 2B;

FIGS. 5A and 5B are illustrations showing the structure of vertically split column direction wiring;

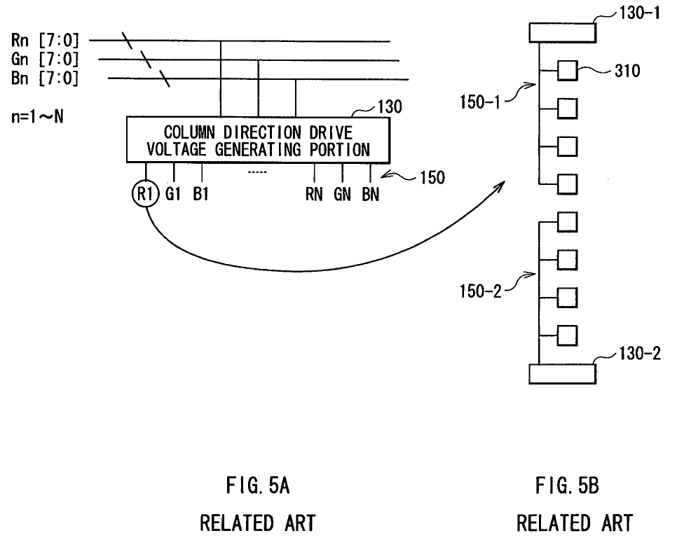

FIGS. 6A and 6B are illustrations showing a first example of scan timing in the matrix type display unit with a vertically split structure shown in FIGS. 5A and 5B;

FIGS. 7A and 7B are illustrations showing a second example of scan timing in the matrix type display unit with the vertically split structure shown in FIGS. 5A and 5B;

FIGS. 8A and 8B are illustrations showing a problem in scan timing shown in FIGS. 7A and 7B;

FIGS. 9A and 9B are illustrations showing the structure of column direction wires by alternate wiring;

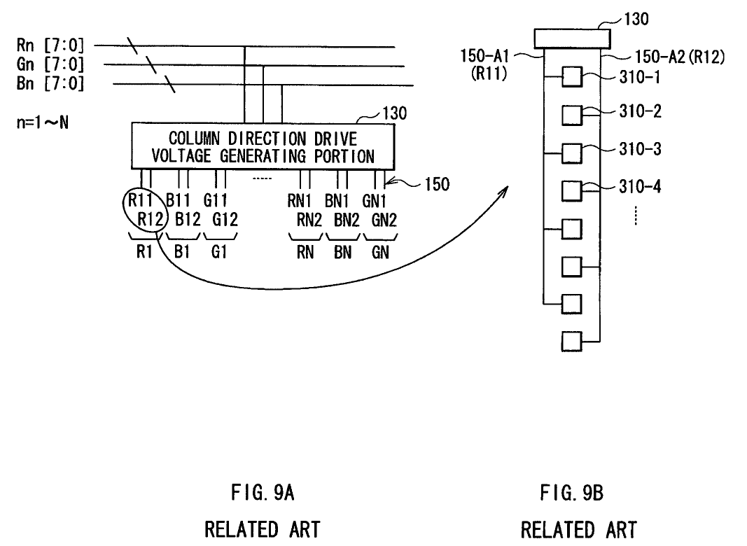

FIGS. 10A and 10B are illustrations showing an example of scan timing in a matrix type display unit with an alternate wiring structure shown in FIGS. 9A and 9B;

FIGS. 11A and 11B are illustrations showing an example of a driving method in the matrix type display unit with the alternate wiring structure shown in FIGS. 9A and 9B;

FIG. 12 is a block diagram showing the whole structure of a matrix type display unit according to an embodiment of the invention;

FIG. 13 is a schematic view showing the structure of a display panel in the matrix type display unit shown in FIG. 12;

FIG. 14 is a schematic sectional view showing the structure of a pixel portion in the matrix type display unit shown in FIG. 12;

FIGS. 15A and 15B are illustrations showing the structure of column direction wiring in the matrix type display unit shown in FIG. 12;

FIGS. 16A through 16L are timing charts showing waveforms of various driving signals in the matrix type display unit shown in FIG. 12;

FIGS. 17A and 17B are illustrations showing an example of scan timing in a method of driving a matrix type display unit according to an embodiment of the invention;

FIGS. 18A and 18B are illustrations showing an example of a driving method in a matrix type display unit according to an embodiment of the invention; and

FIGS. 19A and 19B are illustrations showing an example of image degradation in the case where delay scanning is performed.

### DETAILED DESCRIPTION OF THE PREFERRED EMBODIMENTS

A preferred embodiment will be described in detail below referring to the accompanying drawings.

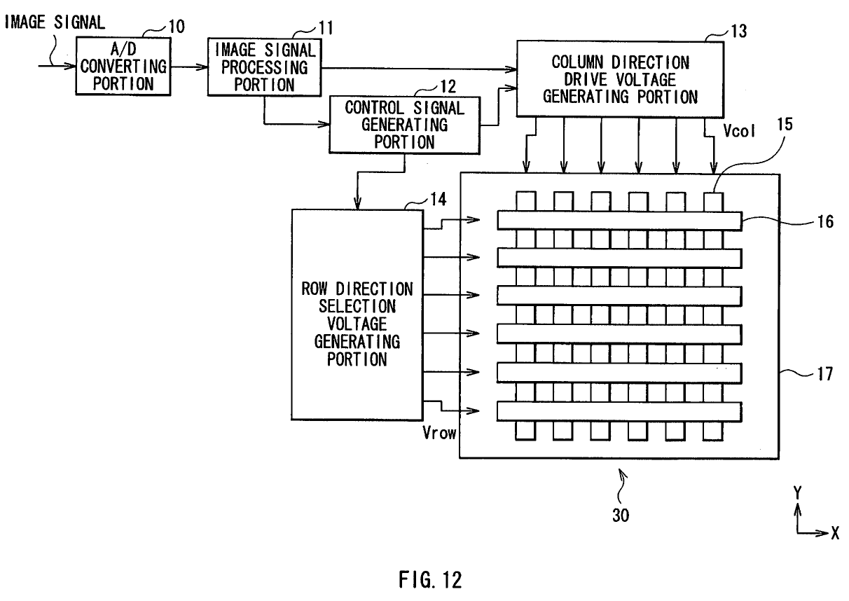

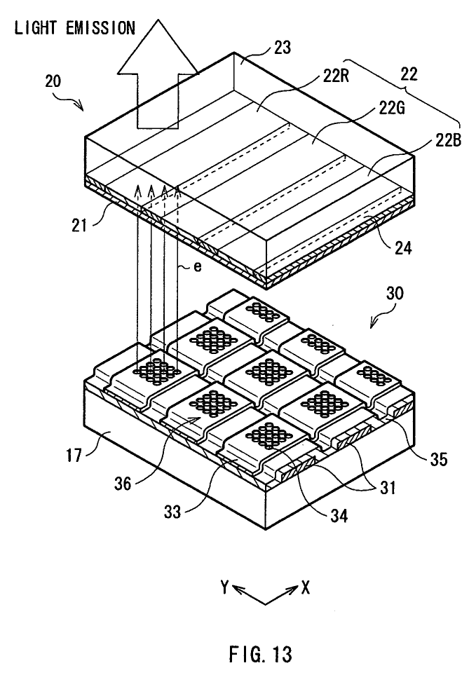

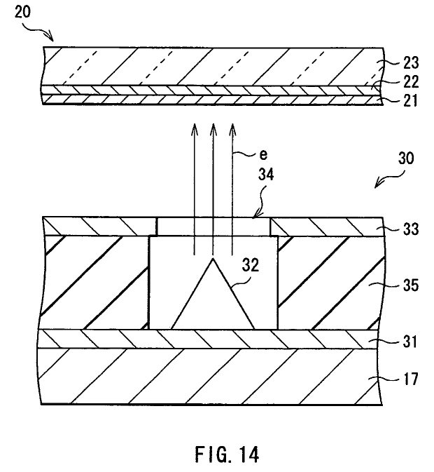

FIG. 12 shows the whole structure of a matrix type display unit according to an embodiment of the invention. FIG. 13 schematically shows the structure of a display panel in the matrix type display unit. FIG. 14 schematically shows the structure of a pixel portion of the display panel. In the embodiment, a matrix type display unit using a FED as a display panel will be described as an example.

As shown in FIG. 12, the matrix type display unit includes an A/D (analog/digital) converting portion 10 which converts an analog image signal into a digital signal to output the digital signal, an image signal processing portion 11 which performs various signal processing such as image quality adjustment on a digital image signal, a column direction drive voltage generating portion 13 and a row direction selection voltage generating portion 14 which drive the display panel, and a control signal generating portion 12 which outputs an appropriate timing pulse to the column direction drive voltage generating portion 13 and the row direction selection voltage generating portion 14 through using a horizontal synchronous signal H and a vertical synchronous signal V included in a image signal as inputs. The image signal inputted into the image signal processing portion 11 includes 8-bit digital image signals for R (red), G (green) and B (blue) and the horizontal synchronous signal H and the vertical synchronous signal V. In the case where a digital signal is inputted as an image signal from the start, the A/D converting portion 10 can be removed.

As shown in FIGS. 13 and 14, the display panel includes an anode panel 20 and a cathode panel 30 which face each other with a predetermined space in between. An electron emission region 36 between the anode panel 20 and the cathode panel 30 is maintained in an almost vacuum state.

The anode panel 20 includes an anode electrode 21 made of a transparent body with a layer shape which is formed on a substrate portion 23 made of, for example, a glass substrate. The anode electrode 21 is coated with a phosphor layer 22. The phosphor layer 22 includes three phosphor layers 22R, 22G and 22B corresponding to the primary colors R (red), G (green) and B (blue) of light. A color image can be displayed by light emission from the phosphor layers 22R, 22G and 22B. A black matrix 24 is formed between the phosphor layers 22R, 22G and 22B. In order to simplify the description, the embodiment will be described without distinction between colors in color display, except for the case where the distinction of colors is specifically necessary.

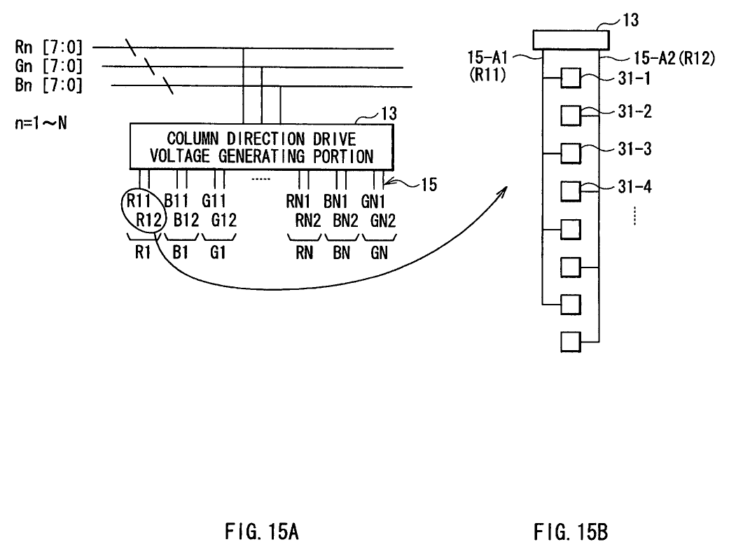

The cathode panel 30 includes a supporting body 17, a column direction wire 15 and a row direction wire 16 which are disposed on the top surface of the supporting body 17. The column direction wire 15 extends to a column direction (a Y direction in FIG. 12), and a plurality of column direction wires 15 are aligned in a row direction (an X direction in FIG. 12). An end of each column direction wire 15 is electrically connected to the column direction drive voltage generating portion 13. The wiring structure in the embodiment is an alternate wiring structure as will be described later referring to FIG. 15B, and as the column direction wire 15, two column wires 15-A1 and 15-A2 are disposed for pixels in one column. The row direction wire 16 extends to a row direction, and a plurality of row direction wires 16 are aligned in a column direction. An end of each row direction wire 16 is electrically connected to the row direction selection voltage generating portion 14. A display pixel is formed at each of intersections of the column direction wires 15 and the row direction wires 16 which are aligned in a matrix form so as to cross each other, and the display pixel at each of the intersections emits light according to a voltage difference between a column wire drive voltage Vcol applied through the column direction wire 15 and a row wire selection voltage Vrow applied through the row direction wire 16.

In the embodiment, the row direction selection voltage generating portion 14 corresponds to a specific example of “a scanning signal applying section” in the invention, and the column direction drive voltage generating portion 13 corresponds to a specific example of “a modulation signal applying section” in the invention. Moreover, in the embodiment, the row wire selection voltage Vrow corresponds to a specific example of “a scanning signal” in the invention, and the column wire drive voltage Vcol corresponds to a specific example of “a modulation signal” in the invention.

In the cathode panel 30, a cathode electrode 31 is formed on the supporting body 17. As shown in FIG. 14, for example, a conical cathode device (cold cathode device) 32 is disposed on the cathode electrode 31. In general, a plurality of cathode devices 32 are disposed for 1 pixel. The cathode electrode 31 and the cathode devices 32 are electrically connected to each other. The cathode electrode 31 and the cathode devices 32 constitute to a field emission cathode.

A gate electrode 33 is disposed on a side facing the cathode electrode 31 with the cathode devices 32 and an insulating layer 35 in between. When a voltage Vgc is applied between the cathode electrode 31 and the gate electrode 33 facing each other, electrons e are emitted from the cathode devices 32. In the gate electrode 33, an aperture portion 34 through which the electrons e emitted from each cathode device 32 pass is disposed in a portion corresponding to the cathode device 32.

The anode electrode 21 faces the gate electrode 33 on a side of a direction where the electrons e are emitted from the cathode device 32. The anode electrode 21 acts as an acceleration electrode. In other words, when a high voltage HV is applied to the anode electrode 21, the electrons e emitted from the cathode device 32 is accelerated toward the anode electrode 21.

Such a pixel structure is formed at each of the intersections of the row direction wires 16 and the column direction wires 15 in the cathode panel 30 so as to form pixels in a matrix form. In general, the gate electrode 33 is electrically connected to the row direction wires 16, and the cathode electrode 31 is electrically connected to the column direction wires 15. Then, when the row wire selection voltage Vrow is applied to the gate electrode 33 as a scanning signal from a row direction, and the column wire drive voltage Vcol is applied to the cathode electrode 31 as a modulation signal from a column direction, a voltage difference expressed in voltage Vgc occurs between the gate electrode 33 and the cathode electrode 31, and the electrons e are emitted from the cathode drive 32 by an electric field generated by the voltage Vgc. At this time, when the high voltage HV is applied to the anode electrode 21, the electrons e are attracted to the anode electrode 21, thereby an anode current Ia flows in a direction from the anode electrode 21 to the cathode electrode 31. At this time, by the energy of the electrons e which arrive at the anode electrode 21, the phosphor layer 22 in a position corresponding to the anode electrode 21 emits light.

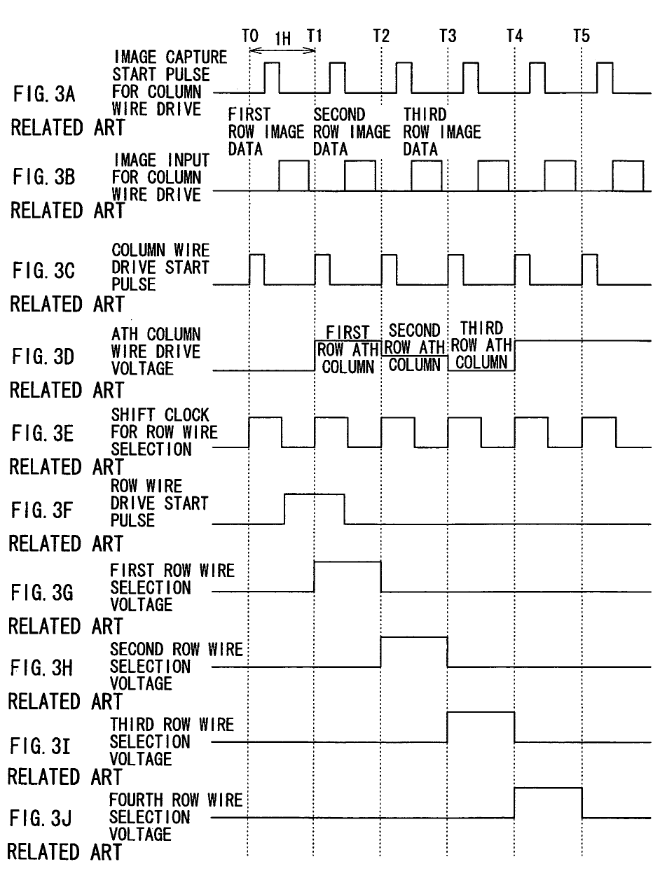

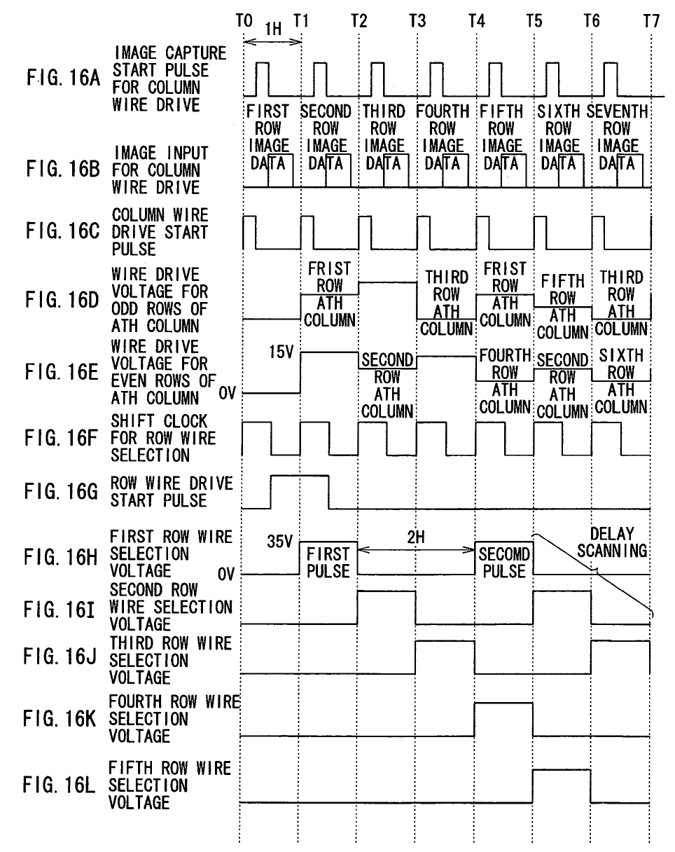

The row direction selection voltage generating portion 14 sequentially applies a scanning signal to each row direction wire 16, and applies the scanning signal (the row wire selection voltage Vrow) to each row direction wire 16 with appropriate timing on the basis of a timing pulse outputted from the control signal generating portion 12. The row wire selection voltage Vrow selects and drives the pixels on a line-by-line basis alternatively and sequentially, and in a typical line sequential driving method in a related art, as is evident from FIGS. 3G through 3J, only one pulse of the row wire selection voltage Vrow in each row exits in 1 frame. However, in the embodiment, as shown in FIGS. 16H through 16L which will be described in detail later, the pulse of the row wire selection voltage Vrow is outputted twice in 1 frame in each row from the row direction selection voltage generating portion 14. Two selection voltage pulses are outputted intermittently, for example, at an interval of a 2H period.

The column direction drive voltage generating portion 13 applies a modulation signal to each column direction wire 15, and mainly includes a shift register for inputting a digital image signal for a plurality of lines, a line memory for a plurality of lines for holding the image signal for a 1H period (=1H period (1 horizontal scanning period), a D/A (digital/analog) converter for converting the digital image signal for the 1H period into an analog voltage to apply the analog voltage for the 1H period, and the like (not shown). The column direction drive voltage generating portion 13 converts a modulation signal corresponding to a digital image signal from the image signal processing portion 11 into an analog modulation signal by a D/A converter (not shown) to apply the analog modulation signal as the column wire drive voltage Vcol to each column direction wire 15.

In the column direction drive voltage generating portion 13, for example, a digital image signal for 4 horizontal lines of pixels can be captured in the shift register, and the digital image signal for 4 horizontal lines of pixels can be held in the line memory. Herein, 4 lines correspond to a line buffer amount which is necessary to achieve the driving method according to the embodiment, and is set to a value according to a scanning delay time D which will be described later.

A plurality of column direction wires R1, G1 and B1 through RN, GN and BN (N=an integer) as the column direction wires 15 for pixel arrays of R, G and B are connected to the column direction drive voltage generating portion 13.

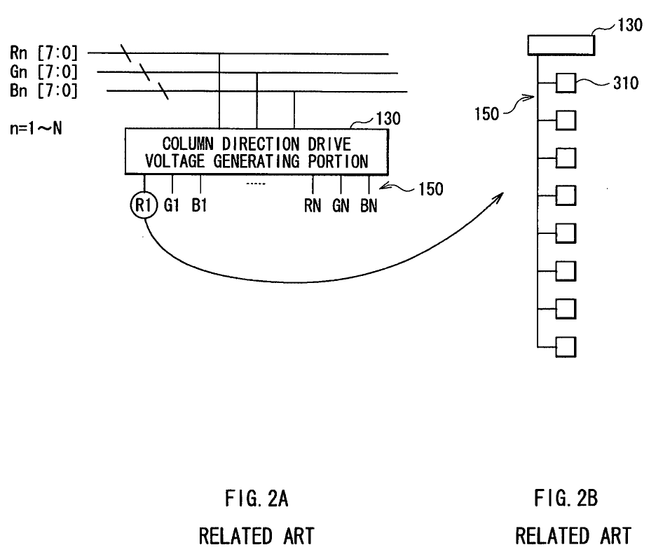

FIGS. 15A and 15B show conceptual diagrams of the connecting structure of the column direction wires 15. In FIG. 15B, the wiring structure of a pixel array in the Ath column is shown as a representative. In a typical wiring structure in a related art, as shown in FIGS. 2A and 2B, all cathode electrodes 310 in one column are connected to one column direction wire 150. On the other hand, in the embodiment, instead of one column direction wire 150 in the related art, one column direction wire 15 includes two column wires 15-A1 and 15-A2, and the two column wires 15-A1 and 15-A2 are alternately connected to the cathode electrodes 31 in one column so as to correspond to a plurality of display pixels in one column in alternate rows.

In other words, compared to the structure in the related art, as shown in FIG. 15A, the column direction wires R1, G1 and B1 through RN, GN and BN for R, G and B include the combinations of two wires (R11, R12), (G11, G12) and (B11, B12) through (RN1, RN2), (GN1, GN2) and (BN1, BN2), respectively. Moreover, as shown in FIG. 15B, wires R11 and R12 are alternately connected to the cathode electrodes 31-1, 31-2, 31-3, . . . in one column.

Thus, the column direction wire 15-A for an arbitrary Ath column includes two wires, that is, a first wire and a second wire (the A1th column wire 15-A1 and the A2th column wire 15-A2), and the cathode electrodes 31-1, 31-3, . . . in odd rows of the Ath column are connected to the first column wire 15-A1, and the cathode electrodes 31-2, 31-4, . . . in even rows are connected to the second column wire 15-A2. Thereby, pixels in odd rows of the Ath column are driven by the A1th column wire 15-A1 and the row direction wires in odd rows, and pixels in even rows of the Ath column are driven by the A2th column wire 15-A2 and the row direction wires in even rows.

The column direction drive voltage generating portion 13 outputs a wire drive voltage for odd rows of the Ath column and a wire drive voltage for even rows of the Ath column to the two column wires 15-A1 and 15-A2 in the Ath column. Thereby, the pixels corresponding to two column wires 15-A1 and 15-A2 are independently driven. A specific example of drive control by the column direction drive voltage generating portion 13 will be described in detail later.

Next, the operation of the matrix type display unit with the above structure will be described below.

At first, the basic operation of the matrix type display unit will be described below. In FIG. 12, an analog image signal inputted into the A/D converting portion 10 is converted into a digital image signal so as to output the digital image signal to the image signal processing portion 11. In the image signal processing portion 11, various signal processing such as image quality adjustment is performed on the digital image signal. The image signal includes, for example, 8-bit digital image signals for R, G and B, the horizontal synchronous signal H and the vertical synchronous signal V. The digital image signals for R, G and B are inputted into the column direction drive voltage generating portion 13.

On the other hand, the horizontal synchronous signal H and the vertical synchronous signal V are inputted into the control signal generating portion 12, and the control signal generating portion 12 generates an image capture start pulse for column wire drive which indicates timing for starting to capture an image in the column direction drive voltage generating portion 13 and a column wire drive start pulse which indicates timing for generating an analog image voltage which is D/A converted in the column direction drive voltage generating portion 13. The control signal generating portion 12 further generates a row wire drive start pulse indicating timing for starting to drive the row wire selection voltage Vrow in the row direction selection voltage generating portion 14 and a shift clock for row wire selection as a reference shift clock for sequentially selecting and driving the row wire selection voltage Vrow on a line-by-line basis from above. The column direction drive voltage generating portion 13 and the row direction selection voltage generating portion 14 drive the display panel with timing based on a drive timing pulse generated on the basis of the synchronous signals.

The row direction selection voltage generating portion 14 sequentially applies the row wire selection voltage Vrow as a scanning signal to each row direction wire 16. The column direction drive voltage generating portion 13 applies the column wire drive voltage Vcol as a modulation signal to each column direction wire 15. In the panel structure shown in FIGS. 13 and 14, the gate electrode 33 is electrically connected to the row direction wire 16, and the cathode electrode 31 is electrically connected to the column direction wire 15, so the row wire selection voltage Vrow is applied to the gate electrode 33 from a row direction, and the column wire drive voltage Vcol is applied to the cathode electrode 31 from a column direction. Thereby, a voltage difference between the gate electrode 33 and the cathode electrode 31 which is expressed in the voltage Vgc occurs, and by an electric field generated by the voltage Vgc, the electrons e are emitted from the cathode device 32. The emitted electrons e are accelerated by the anode electrode 21 to hit the anode electrode 21. By the energy of the electrons e hitting the anode electrode 21, the phosphor layer 22 in a position corresponding to the anode electrode 21 hit by the electrons e emits light. An image is displayed by light emission.

Next, the driving operation of the display panel which is a characteristic part of the matrix type display unit will be described in more detail below. FIGS. 16A through 16L show drive timing of the display panel in the matrix type display unit. The image input for column wire drive in FIG. 16B is, for example, total 24 bits of digital image signals including 8-bit signals for R, G and B inputted into the column direction drive voltage generating portion 13 in parallel as shown in FIG. 15A, and one pixel is sampled by a reference dot clock for digital image signal reproduction (not shown).

In the column direction drive voltage generating portion 13, just before the image input for column wire drive (for example, 1 clock in dot clock before), the image capture start pulse for column wire drive (refer to FIG. 16A) from the control signal generating portion 12 is detected, and after that, the image input for column wire drive is held, for example, through capturing the image input for column wire drive, for example, in the shift register for 4 horizontal lines of pixels which sequentially stores the image input for column wire drive in synchronization with a dot clock. In this case, 4 lines correspond to a line buffer amount which is necessary to achieve the driving method according to the embodiment.

Next, in the column direction drive voltage generating portion 13, in synchronization with the column wire drive start pulse (refer to FIGS. 16C) from the control signal generating portion 12 which is detected after one line of image input data for column wire drive is captured, one line of image data is transferred to, for example, the line memory, and one line of image data held in the line memory is D/A converted on a pixel-by-pixel basis at the same time, and the one line of image date is outputted as a column wire drive voltage for odd rows and a column wire drive voltage for even rows which are analog voltages. FIGS. 16D and 16E show an wire drive voltage for odd rows of the Ath column and an wire drive voltage for even rows of the Ath column as representatives of the column wire drive voltage for driving the Ath pixel in a horizontal direction as an example. The wire drive voltage for odd rows of the Ath column is outputted to the A1th column wire 15-A1 in FIG. 15B, and the wire drive voltage for even rows of the Ath column is outputted to the A2th column wire 15-A2 in FIG. 15B.

On the other hand, in the row direction selection voltage generating portion 14, the on state of the row wire drive start pulse (refer to FIG. 16G) from the control signal generating portion 12 is detected, for example, on the rising edge of the column wire drive start pulse (refer to FIG. 16C). Then, the row wire selection voltage Vrow is sequentially applied to the first row to the last row (refer to FIGS. 16H through 16L) in synchronization with the shift clock for row wire selection (refer to FIG. 16F) on the rising edge of the column wire drive start pulse as a starting point. In the drawings, selection voltages for the first row to the fifth row are shown.

When a difference voltage Vgc between the row wire selection voltage Vrow and the column wire drive voltage Vcol is applied to the cathode device 32 with such timing, the amount of electron beam irradiation to the phosphor is controlled so as to display an image.

In the embodiment, the pulse of the row wire selection voltage Vrow is outputted twice in 1 frame in each row from the row direction selection voltage generating portion 14. As shown in FIG. 16H, the second voltage pulse is outputted after an interval of, for example, a 2H period from the first voltage pulse. In other words, in the embodiment, the pulse of the row wire selection voltage Vrow is intermittently outputted twice so as to perform delay scanning after a predetermined period.

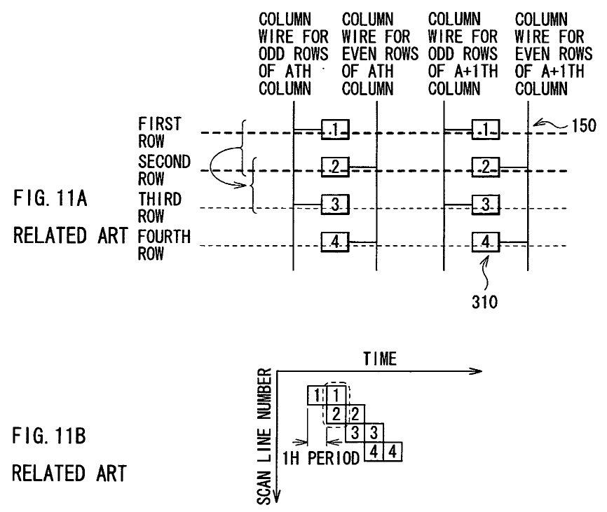

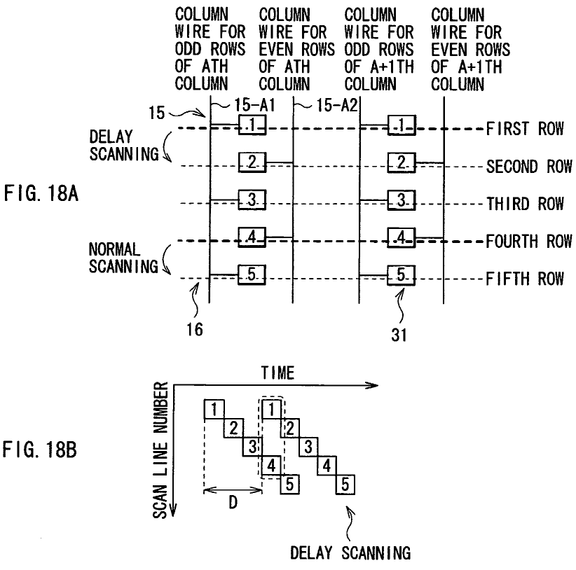

FIGS. 18A and 18B schematically show the concept of scan timing in the driving method according to the embodiment. A driving method in an alternate wiring structure in a related art is as shown in FIGS. 11A and 11B. In the driving method in the related art, adjacent two lines are scanned successively. For example, the first row and the second row are scanned at the same time, and then the second row and the third row are scanned at the same time. In the driving method in the related art, the pulse of the row wire selection voltage Vrow is successively outputted in each row during a 2H period, that is, a pulse with a pulse width of a 2H period is outputted, thereby continuous light emission for a 2H period occurs in each row at all time.

On the other hand, in the driving method according to the embodiment, the pulse of the row wire selection voltage Vrow is intermittently outputted twice in each row, and after a predetermined interval, delay scanning is performed, thereby light emission in each row is not continuous light emission for a 2H period, and light emission for a 1H period is performed twice at an interval of a 2H period. In FIG. 18A, a line highlighted with a heavy dotted line indicates a row being scanned, and corresponds to scanning in a part enclosed with a dotted line in FIG. 18B. In other words, in FIG. 18A, the line in the fourth row is scanned with normal timing, and delay scanning is performed on the line in the first row. At this time, the column wire drive voltage Vcol corresponding to normal scanning and delay scanning is applied. The display panel according to the embodiment has an alternate wiring structure in which two column wires 15-A1 and 15-A2 are alternately connected to the display pixels in one column, so as the column wire drive voltage Vcol, the column wire drive voltage for odd rows is applied to the column wire for odd rows (the first column wire) in each column, and the column wire drive voltage for even rows is applied to the column wire for even rows (the second column wire) in each column at the same time, thereby the pixels on the lines in the odd rows and the pixels on the lines in the even rows can be driven independently and concurrently. In other words, a pixel on the line in the fourth row and a pixel on the line in the first row can be driven independently and concurrently. Thereby, delay scanning is performed on the line in the first row, so the second light emission occurs in the pixel in the first row. After that, the line in the fifth row is scanned with normal timing, and delay scanning is performed on the line in the second row. Likewise, normal scanning and delay scanning are performed sequentially and alternatively on each line, and light emission intermittently occurs in the pixel in each row twice.

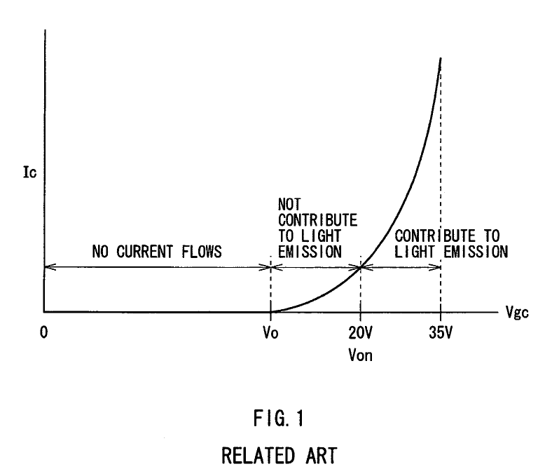

A description will be given referring to FIGS. 16A through 16L again. In the following description, the cutoff voltage Von (refer to FIG. 1) of the difference voltage Vgc is 20 V; the row wire selection voltage Vrow is 35 V at the time of selection and 0 V at the time of non-selection; and the column wire drive voltage Vol is variably controlled within a range from 0 V (white level) to 15 V (black level) according to an input image signal level.

At first, at a time T1, in the column direction drive voltage generating portion 13, the pixel data for the Ath column in the first row image data (refer to FIG. 16B) held by the line memory (not shown) is D/A converted and outputted as the wire drive voltage for odd rows of the Ath column (refer to FIG. 16D) during a period from the time T1 to a time T2. Moreover, the first row wire selection voltage (refer to FIG. 16H) of 35 V is outputted from the row direction selection voltage generating portion 14 as the row wire selection voltage Vrow, and the difference voltage Vgc therebetween is applied between the gate electrode 33 and the cathode electrode 31 so as to drive the pixel in the first row of the Ath column. At this time, in order to prevent the pixels in the even rows of the Ath column from emitting light, a voltage of 15 V is outputted as the wire drive voltage for even rows of the Ath column (refer to FIG. 16E).

Next, at the time T2, in the column direction drive voltage generating portion 13, the pixel data for the Ath column in the second row image data (refer to FIG. 16B) held by the line memory (not shown) is D/A converted and outputted as the wire drive voltage for even rows of the Ath column (refer to FIG. 16E) during a period from the time T2 to a time T3. Moreover, the second row wire selection voltage (refer to FIG. 16I) of 35 V is outputted from the row direction selection voltage generating portion 14 as the row wire selection voltage Vrow, and a difference voltage Vgc therebetween is applied between the gate electrode 33 and the cathode electrode 31 so as to drive the pixel in the second row of the Ath column. At this time, in order to prevent the pixels in the odd rows of the Ath column from emitting light, a voltage of 15 V is outputted as the wire drive voltage for odd rows of the Ath column (refer to FIG. 16D).

Next, at the time T3, in the column direction drive voltage generating portion 13, the pixel data for the Ath column in the third row image data (refer to FIG. 16B) held by the line memory (not shown) is D/A converted and outputted as the wire drive voltage for odd rows of the Ath column (refer to FIG. 16D) during a period from the time T3 to a time T4. Moreover, the third row wire selection voltage (refer to FIG. 16J) is outputted from the row direction selection voltage generating portion 14 as the row wire selection voltage Vrow, and a difference voltage Vgc therebetween is applied between the gate electrode 33 and the cathode electrode 31 so as to drive the pixel in the third row of the Ath column. At this time, in order to prevent the pixels in the even rows of the Ath column from emitting light, a voltage of 15 V is outputted as the wire drive voltage for even rows of the Ath column (refer to FIG. 16 E).

Next, at the time T4, in the column direction drive voltage generating portion 13, the pixel data for the Ath column in the fourth row image data (refer to FIG. 16B) held by the line memory (not shown) is D/A converted and outputted as the wire drive voltage for even rows of the Ath column (refer to FIG. 16E) during a period from the time T4 to a time T5. Moreover, the fourth row wire selection voltage of 35 V is outputted as the row wire selection voltage Vrow from the row direction selection voltage generating portion 14, and a difference voltage Vgc therebetween is applied between the gate electrode 33 and the cathode electrode 31 so as to drive the pixel in the fourth row of the Ath column.

At the time T4, in the column direction drive voltage generating portion 13, the pixel data for the Ath column in the first row image data (refer to FIG. 16B) continuously held by the line memory (not shown) from the time T1 is D/A converted and outputted as the wire drive voltage for odd rows of the Ath column during a period from the time T4 to a time T5. Moreover, the first row wire selection voltage (refer to FIG. 16H) of 35 V is outputted from the row direction selection voltage generating portion 14 as the row wire selection voltage Vrow, and a difference voltage Vgc therebetween is applied between the gate electrode 33 and the cathode electrode 31 so as to drive the pixel in the first row of the Ath column again. In other words, during the period from the time T4 to the time T5, the pixel in the fourth row and the Ath column is driven with normal scan timing, and the pixel in the first row of the Ath column is driven again by delay scanning.

Next, at the time T5, in the column direction drive voltage generating portion 13, the pixel data for the Ath column in the fifth row image data (refer to FIG. 16B) held by the line memory (not shown) is D/A converted and outputted during a period from the time T5 and a time T6 as the wire drive voltage for odd rows of the Ath column (refer to FIG. 16D). Moreover, the fifth row wire selection voltage (refer to FIG. 16L) of 35 V is outputted from the row direction selection voltage generating portion 14 as the row wire selection voltage Vrow, and a difference voltage Vgc therebetween is applied between the gate electrode 33 and the cathode electrode 31 so as to drive the pixel in the fifth row of the Ath column.

At the time T5, in the column direction drive voltage generating portion 13, the pixel data for the Ath column in the second row image data (refer to FIG. 16B) continuously held by the line memory (not shown) from the time T2 is D/A converted and outputted as the wire drive voltage for even rows of the Ath column (FIG. 16E) during a period from the time T5 to the time T6. Moreover, the second row wire selection voltage (refer to FIG. 16I) of 35 V is outputted from the row direction selection voltage generating portion 14 as the row wire selection voltage Vrow, and a difference voltage therebetween is applied between the gate electrode 33 and the cathode electrode 31 so as to drive the pixel in the second row of the Ath column again. In other words, during the period from the time T5 to the time T6, the pixel in the fifth row of the Ath column is driven with normal scan timing, and the pixel in the second row of the Ath column is driven by delay scanning again.

Thus, in the embodiment, the column direction drive voltage generating portion 13 includes the line memory for holding pixel data for 4 lines, and the pixel data corresponding to the present scan line and the pixel data corresponding to the third line from the present scan line are read out at the same time, and drive control in which they are allocated to the even row wire drive voltage and the odd row wire drive voltage according to the scanning time to be outputted is carried out to achieve delay scanning.

Although only the drive during a period from the time T1 to the time T5 is described, in the embodiment, such drive is regularly carried out during one vertical scanning period.

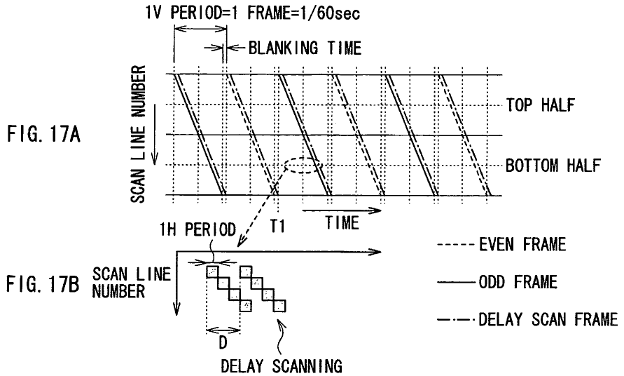

FIGS. 17A and 17B macroscopically show an example of scan timing in each line in the case where the panel is scanned by such a driving method. The horizontal direction indicates time, and the vertical direction indicates scan line number. FIG. 17B shows an enlarged partial view of FIG. 17A. In the drawings, for the sake of convenience, frames with normal timing are divided into even frames and odd frames. The time T1 in FIG. 17A means the time T1 in FIGS. 16A through 16L.

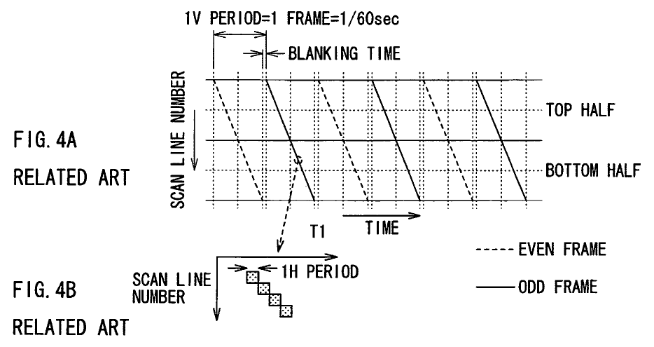

As is evident from FIGS. 17A and 17B, in the driving method according to the embodiment, typical line sequential scanning in the related art (refer to FIGS. 4A and 4B) is performed twice at an interval of a delay time of a few H period. In other words, a display period per line by scanning is still a 1H period of a input image signal, so when the display period is converted into a vertical scanning period 1V of the input image signal, the light emission for a 1H period occurs twice, that is, the light emission time is doubled, so compared to the case of the typical line sequential scanning in the related art (refer to FIGS. 4A and 4B), the brightness is doubled.

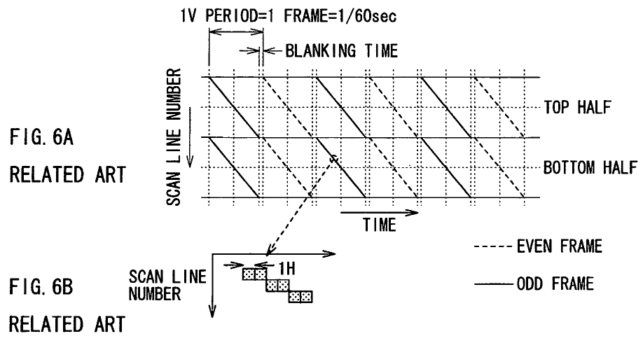

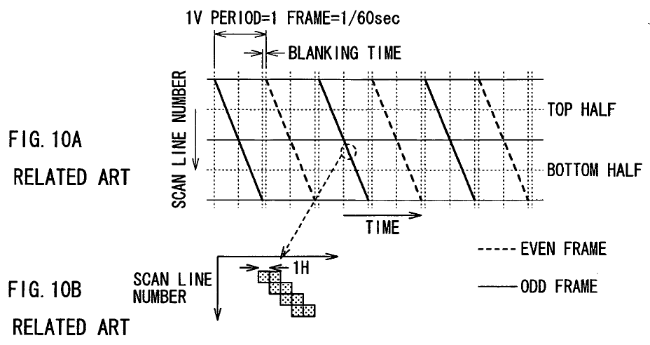

Moreover, in the same line, there is a time interval (for example, a 2H period) between the light emission by the first scanning and the light emission by the second scanning, so compared to the case where continuous light emission for a 2H period is performed as in the case of FIGS. 6A, 6B, 10A and 10B, the brightness saturation of the phosphor can be overcome. Thereby, the gray scale representation on a high brightness side can be improved.

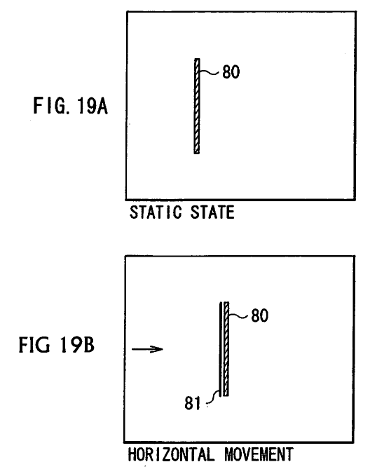

Further, in terms of image quality, in the driving method according to the embodiment, the same image is displayed again after a delay of a predetermined time. In this case, when moving images are followed, it is known that a so-called image blur shown in FIG. 19B occurs. In other words, when an object image 80 which is as shown in FIG. 19A in a static state horizontally moves from the left to the right on a screen, as shown in FIG. 19B, an object image 81 is generated on the left side of the original object image 80 because of display delay. However, when the delay time is as short as a few H period, such image quality degradation is hardly noticed. Even in the case where the delay time is longer, for example, when an interpolation frame generating circuit is used to produce an image signal corrected according to the delay time in the second scanning, and a column direction drive voltage based on the image signal is applied, the image quality degradation can be overcome. Conversely, in the case where the delay time is as short as a few H period, the interpolation frame generating circuit for preventing the image blur is not necessary.

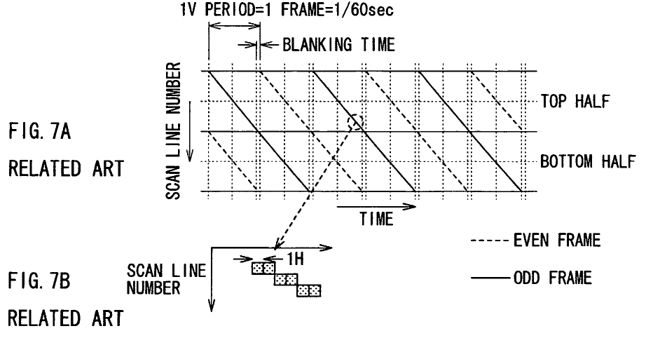

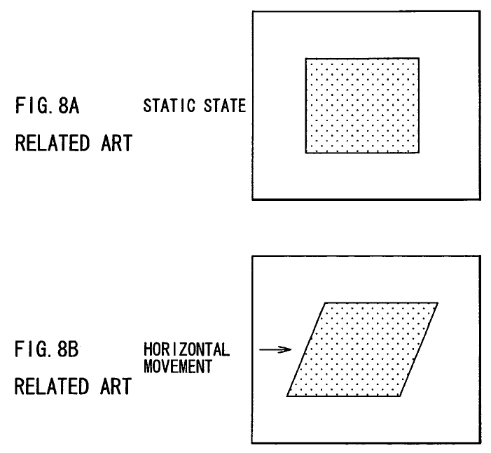

In the driving method according to the embodiment, the actual image scanning period per screen corresponds to the vertical scanning period of the input image signal, so large screen distortion as shown in FIG. 8B due to the mismatch between the actual timing of image scanning and the timing period of the input image signal which occurs in the case of a second driving method (refer to FIGS. 7A and 7B) with the above-described vertically split wiring structure does not occur. Moreover, the discontinuity of moving images in a central portion of the screen which occurs in the first driving method with the vertically split wiring structure (refer to FIGS. 6A and 6B) does not occur. In the driving method according to the embodiment, while improving the brightness, superior image display can be achieved.

In the embodiment, the case where the scanning delay time D (refer to FIGS. 17B and 18B) from the starting time of the first scanning to the starting time of the second scanning is a 3H period, and the light emission interval is a 2H period is described as an example; however, their values may be changed. In other words, the values can be adjusted within a range in which the brightness saturation can be appropriately overcome, and the image blur is unnoticed according to the number of image vertical lines. However, it is necessary to increase or decrease the number of lines of image data held in the column direction drive voltage generating portion 13 according to the adjustment. Moreover, it is considered that it is practically suitable that the delay time D is set to a half of the vertical scanning period V or less, that is, V/2 or less because of the image blur shown in FIG. 19B. More preferably, as describe above, when the delay time D is a few H period, the image quality degradation is hardly noticed, so the delay time D is preferably set to a few H period.

As described above, in the embodiment, when the display panel with an alternate wiring structure is driven, after a normal scanning signal is applied, the same pixel is displayed again with the scan timing delayed from the normal scan timing after a lapse of a predetermined period, so even if the resolution becomes higher and the screen become larger, the brightness saturation of the phosphor can be overcome, and the light emission brightness can be improved without impairing the image quality. Thereby, superior display brightness and superior gray scale characteristics can be obtained.

The invention is not limited to the above-described embodiment, and can be variously modified. For example, in the above-described embodiment, the case where the vertical scanning period of the input image signal is 1/60 sec is described as an example; however, even if the period is set to any other value, the same operation can be achieved, and the same effects are expected, so it is within an applicable range of the invention. Moreover, the normal scanning and the delay scanning each are performed once per frame of image display; however, the delay scanning may be performed a plurality of times. Thereby, the brightness can be further improved.

Further, in the above-described embodiment, a voltage drive type driving method in which the magnitude of the brightness is variable according to the voltage level of the voltage Vgc between the gate and the cathode is described as an example; however, the invention can be easily applied to a pulse drive type driving method in which the voltage level of the voltage Vgc between the gate and the cathode is fixed, and gray scales are represented according to the time when the voltage Vgc is applied. Further, the case where the FED is used as a display panel is described as an example; however, the invention can be applied to the case where any other types of display panels such as an EL type display panel are used.

It should be understood by those skilled in the art that various modifications, combinations, sub-combinations and alterations may occur depending on design requirements and other factors insofar as they are within the scope of the appended claims or the equivalents thereof.

1. A matrix type display unit including a plurality of row wires, and a plurality of column wires which are disposed so as to cross over the plurality of row wires wherein a plurality of display pixels are formed in a matrix form corresponding to intersections of the plurality of row wires and the plurality of column wires, the matrix type display unit comprising:
a means for applying a scanning signal which performs scanning on each frame of image display through sequentially and alternatively applying a scanning signal to each of the plurality of row wires on a line-by-line basis with normal scan timing, and sequentially and alternatively applying the scanning signal again with scan timing delayed for a predetermined period from the normal scan timing after applying the scanning signal; and
a means for applying a modulation signal corresponding to each pixel to a pixel on a line to which the scanning signal is applied with the normal scan timing and a pixel on a line to which the scanning signal is applied with the delay scan timing.

2. A matrix type display unit according to claim 1, wherein
each of the plurality of column wires includes a first column wire and a second column wire in each display pixel array, and the first column wire is disposed so as to correspond to a display pixel in an odd row, and the second column wire is disposed so as to correspond to a display pixel in an even row, and
in the means for applying a scanning signal, when the scanning signal is applied to a row wire in an odd row with the normal scan timing, the scanning signal is applied to a row wire in an even row with the delay scan timing, and when the scanning signal is applied to a row wire in an even row with the normal scan timing, the scanning signal is applied to a row wire in an odd row with the delay scan timing, and
in the means for applying a modulation signal, a modulation signal is independently applied to the first column wire and the second column wire so that a modulation signal for each line can be independently and concurrently applied to a display pixel in an odd row and a display pixel in an even row.

3. A method of driving a matrix type display unit, the matrix type display including a plurality of row wires, and a plurality of column wires disposed so as to cross over the plurality of row wires wherein a plurality of display pixels are formed in a matrix form corresponding to intersections of the plurality of row wires and the plurality of column wires, the method comprising:
a scanning signal applying step of performing scanning on each frame of image display through sequentially and alternatively applying a scanning signal to each of the plurality of row wires on a line-by-line basis with normal scan timing, and sequentially and alternatively applying the scanning signal again with scan timing delayed for a predetermined period from the normal scan timing after applying the scanning signal; and
a modulation signal applying step of applying a modulation signal corresponding to each pixel to a pixel on a line to which the scanning signal is applied with the normal scan timing and a pixel on a line to which the scanning signal is applied with the delay scan timing.

4. A method of driving a matrix type display unit according to claim 3, wherein
each of the plurality of column wires includes a first column wire and a second column wire in each display pixel array, and the first column wire is disposed so as to correspond to a display pixel in an odd row, and the second column wire is disposed so as to correspond to a display pixel in an even row, and
in the scanning signal applying step, when the scanning signal is applied to a row wire in an odd row with the normal scan timing, the scanning signal is applied to a row wire in an even row with the delay scan timing, and when the scanning signal is applied to a row wire in an even row with the normal scan timing, the scanning signal is applied to a row wire in an odd row with the delay scan timing, and
in the modulation signal applying section, a modulation signal is independently applied to the first column wire and the second column wire so that a modulation signal for each line can be independently and concurrently applied to a display pixel in an odd row and a display pixel in an even row.

5. A matrix type display unit including a plurality of row wires, and a plurality of column wires which are disposed so as to cross over the plurality of row wires wherein a plurality of display pixels are formed in a matrix form corresponding to intersections of the plurality of row wires and the plurality of column wires, the matrix type display unit comprising:
a scanning signal applying section performing scanning on each frame of image display through sequentially and alternatively applying a scanning signal to each of the plurality of row wires on a line-by-line basis with normal scan timing, and sequentially and alternatively applying the scanning signal again with scan timing delayed for a predetermined period from the normal scan timing after applying the scanning signal; and
a modulation signal applying section applying a modulation signal corresponding to each pixel to a pixel on a line to which the scanning signal is applied with the normal scan timing and a pixel on a line to which the scanning signal is applied with the delay scan timing.
